(19) United States
(12) Patent Application Publication
(10) Pub. No.: US 2019/0215043 A1
(43) Pub. Date: Jul. 11, 2019

(54) BEAMFORMING SCHEDULING IN A DISTRIBUTION NETWORK

(71) Applicant: QUALCOMM Incorporated, San Diego, CA (US)

(72) Inventors: Solomon TRAININ, Haifa (IL); Assaf Yaakov KASHER, Haifa (IL); Alecsander Petru EITAN, Haifa (IL); Amichai SANDEROVICH, Atlit (IL)

(21) Appl. No.: 16/235,198

(22) Filed: Dec. 28, 2018

Related U.S. Application Data
(60) Provisional application No. 62/615,946, filed on Jan. 10, 2018.

(51) Int. Cl. H04B 7/06; H04L 5/14; H04L 5/00

(52) U.S. Cl. CPC H04B 7/0617; H04L 5/0055; H04L 5/14

(57) ABSTRACT

A method and an apparatus for performing beamforming training using time division duplex (TDD) service periods is provided. An initiator device configures slots assigned to a responder device of an existing TDD schedule for the beamforming training. The initiator device transmits one or more packets to trigger an antenna sweep for one or more sectors of a beamforming antenna of the responder device during a first slot of the multiple slots. The first slot is assigned to the responder device for receiving from the initiator device. The responder device performs the antenna sweep for the one or more sectors of the beamforming antenna of the responder device. The responder device transmits to the initiator device an acknowledgement of the antenna sweep in a second slot of the multiple slots assigned to the responder device. The second slot is assigned to the responder device for transmitting to the initiator device.

### CROSS-REFERENCE TO RELATED APPLICATION(S)

This application claims the priority benefit of U.S. Provisional Application Ser. No. 62/615,946, entitled “BEAMFORMING SCHEDULING IN DISTRIBUTION NETWORK” and filed on Jan. 10, 2018, which is expressly incorporated by reference herein in its entirety.

### TECHNICAL FIELD

The present disclosure relates generally to communication systems, and more particularly, to methods and apparatus related to beamforming training of antennas between devices.

### DESCRIPTION OF THE RELATED TECHNOLOGY

In some telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching or routing techniques used to interconnect the various network nodes and devices (such as circuit switching versus packet switching), the type of physical media employed for transmission (such as wired versus wireless), and the set of communication protocols used (such as Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices disclosed herein each have several aspects, no single one of which is solely responsible for the desirable attributes.

Various aspects related to beamforming training using time division duplex (TDD) service period (SP) are described. Multi-Gigabit-per-second (Gbps) communication operating in the unlicensed 60 Gigahertz (GHz) band is emerging for WiFi use. Signal propagation characteristics in the 60 GHz band and other millimeter wave bands, such as increased signal attenuation compared to that at the 2.4 and 5 GHz bands, demands a shift from omni-directional to directional antennas. Beamforming of the antenna pattern using multi-sectors antennas facilitates communication using directional antennas. Beamforming training determines the desirable receive and transmit antenna sectors to use between two communicating nodes. Beamforming training may be scheduled to allow the transmitter or the receiver to sweep its antenna through the various sectors. However, beamforming training may be time consuming due to scheduling delays and contention for access to the medium among multiple nodes. Various aspects of the disclosure use existing TDD channel access schedule to facilitate beamforming training, improving efficiency and shortening latency One aspect of this disclosure provides a method for performing beamforming training by an initiator device (such as a WiFi access point) for wireless communication. The method includes configuring one or more slots assigned to a responder device of an existing time division duplex (TDD) schedule between the initiator device and the responder device for the beamforming training. The method also includes triggering an antenna sweep for one or more sectors of a beamforming antenna of the responder device during a first slot of the one or more slots assigned to the responder device. The method further includes receiving by the initiator device, from the responder device, an acknowledgement of the antenna sweep in a second slot of the one or more slots assigned to the responder device.

Another aspect of this disclosure provides a method for performing beamforming training by a responder device (such as a WiFi station (STA)) for wireless communication. The method includes receiving, from an initiator device, triggers for an antenna sweep for one or more sectors of a beamforming antenna of the responder device during a first slot of one or more slots assigned to the responder device of an existing time division duplex (TDD) schedule between the initiator device and the responder device. The method also includes performing the antenna sweep for the one or more sectors of the beamforming antenna of the responder device during the first slot of the one or more slots assigned to the responder device. The method further includes transmitting, from the responder device to the initiator device, an acknowledgement of the antenna sweep in a second slot of the one or more slots assigned to the responder device.

Another aspect of this disclosure provides a first apparatus. The first apparatus includes one or more processors and at least one memory that stores processor readable code executed by the processors. The processor executes the code to configure one or more slots assigned to a second apparatus of an existing TDD schedule between the first apparatus and the second apparatus for beamforming training. The processor also executes the code to configure a first interface to trigger an antenna sweep for one or more sectors of a beamforming antenna of the second apparatus during a first slot of the one or more slots assigned to the second apparatus. The processor further executes the code to configure a second interface to receive, from the second apparatus, an acknowledgement of the antenna sweep in a second slot of the one or more slots assigned to the second apparatus.

Another aspect of this disclosure provides a first apparatus. The first apparatus includes one or more processors and at least one memory that stores processor readable code executed by the processors. The processor executes the code to configure a first interface to receive from a second apparatus one or more triggers for an antenna sweep for one or more sectors of a beamforming antenna of a wireless device during a first slot of one or more slots that are assigned to the first apparatus of an existing TDD schedule between the second apparatus and the first apparatus. The first apparatus may be part of the wireless device. The processor also executes the code to perform the antenna sweep for the one or more sectors of the beamforming antenna of the wireless device during the first slot of the one or more slots assigned to the first apparatus. The processor further configures a second interface to transmit to the second apparatus an acknowledgement of the antenna sweep in a second slot of the one or more slots assigned to the first apparatus.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example wireless communication system in which aspects of the present disclosure may be employed.

FIG. 2 shows an example of antenna beam patterns from various sectors of two communicating nodes according to one implementation.

FIG. 3 shows an example of a topology of a distributed network that employs TDD access according to one implementation.

FIG. 4 shows an example of beamforming training using scheduled TDD access according to one implementation.

FIG. 5 is a flowchart showing an example method of beamforming training using scheduled TDD access according to one implementation.

FIG. 6 is a flowchart shoring another example method of beamforming training using scheduled TDD access according to one implementation.

FIG. 7 shows a functional block diagram of an example wireless communication apparatus.

FIG. 8 is a conceptual data flow diagram illustrating the data flow between different components in an apparatus.

FIG. 9 is a format for the TDD Beamforming Control Subfield.

FIG. 10 is a format for the TDD Beamforming Information Field.

FIG. 11 is a format for the TDD Responder Antenna Configuration Sub-element.

Like reference numbers and designations in the various drawings indicate like elements.

### DETAILED DESCRIPTION

Various aspects of the novel systems, apparatuses, computer-readable media, and methods are described more fully hereinafter with reference to the accompanying drawings. The innovative aspects may, however, be implemented in many different forms and should not be construed as limited to any specific structures or functions presented throughout this disclosure. Rather, these aspects are provided so that this disclosure will be thorough and complete, and will fully convey the scope of the disclosure to enable persons having ordinary skill in the art to practice the innovative aspects. Based on the teachings herein, persons having ordinary skill in the art should appreciate that the scope of the disclosure is intended to cover any aspects of the innovative systems, apparatuses, computer program products (such as computer-readable media), and methods disclosed herein, whether implemented independently of, or combined with, any other aspects of the disclosure. For example, an apparatus may be implemented or a method may be practiced using any number of the aspects set forth herein. In addition, the scope of the disclosure is intended to cover such an apparatus or method which is practiced using other structures or functionalities in addition to or other than the various aspects set forth herein. It should be understood that any aspect disclosed herein may be implemented by one or more elements of a claim.

Although particular aspects are described herein, many variations and permutations of these aspects fall within the scope of this disclosure. Although some benefits and advantages of particular aspects are described, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following detailed description. While the detailed description and drawings are illustrative of the disclosure, they are not to be understood as limiting.

Popular wireless network technologies may include various types of wireless local area networks (WLANs). A WLAN may be used to interconnect nearby devices together, employing widely used networking protocols. The various aspects described herein may apply to any communication standard or wireless protocol.

In some aspects, wireless signals may be transmitted according to an IEEE 802.11 standard protocol using orthogonal frequency-division multiplexing (OFDM), direct-sequence spread spectrum (DSSS) communications, or a combination of OFDM and DSSS communications, or other schemes. Implementations of the 802.11 protocol may be used for sensors, metering, and smart grid networks. Advantageously, aspects of some devices implementing the 802.11 protocol may consume less power than devices implementing other wireless protocols, or may be used to transmit wireless signals across a relatively long range, for example, about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (such as IEEE 802.11 protocol) compliant wireless link to obtain general connectivity to the Internet or to other wide area networks. In some implementations a STA also may be used as an AP. In this regard, a STA may be described as a virtual AP (which also may be referred to as an AP STA) or a non-AP STA.

An access point also may include, be implemented as, or known as a Node B (NB), Radio Network Controller (RNC), Evolved Node B (eNodeB), Base Station Controller (BSC), Base Transceiver Station (BTS), Base Station (BS), Transceiver Function (TF), Radio Router, Radio Transceiver, connection point, or some other terminology.

A station also may include, be implemented as, or known as an access terminal (AT), a subscriber station, a subscriber unit, a mobile device, a mobile station, a remote station, a remote terminal, a user terminal, a user agent, a user device, a user equipment (UE), or some other terminology. In some implementations, a station may include a cellular telephone, a “smartphone,” a cordless telephone, a Session Initiation Protocol (SIP) phone, a wireless local loop (WLL) station, a personal digital assistant (PDA), a handheld device having wireless connection capability, or some other suitable processing device connected to a wireless modem.

Accordingly, one or more aspects taught herein may be incorporated into a phone (such as a cellular phone or smartphone), a computer (such as a laptop), a portable communication device, a headset, a portable computing device (such as a personal data assistant), an entertainment device (such as a music or video device, or a satellite radio), a gaming device or system, a global positioning system (GPS) device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatuses followed by an “association response” by the other apparatus. It will be understood by persons having ordinary skill in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of A, B or C” is intended to cover: A, B or C individually, or any combination thereof (such as A-B, A-C, B-C, or A-B-C).

As discussed above, some devices described herein may implement an IEEE 802.11 standard, for example, one or more of 802.11a, 802.11b, 802.11g, 802.11n, 802.11ac, 802.11ad, 802.11ah, 802.11ax, 802.1lay, 802.11az and 802.11-EHT. Such devices, whether implemented as a STA or AP or other device, may be used for smart metering or in a smart grid network. Such devices may provide sensor applications or be used in home automation. The devices may instead or in addition be used in a healthcare context, for example for personal healthcare. The devices also may be used for surveillance, to enable extended-range Internet connectivity (such as for use with hotspots), or to implement machine-to-machine communications.

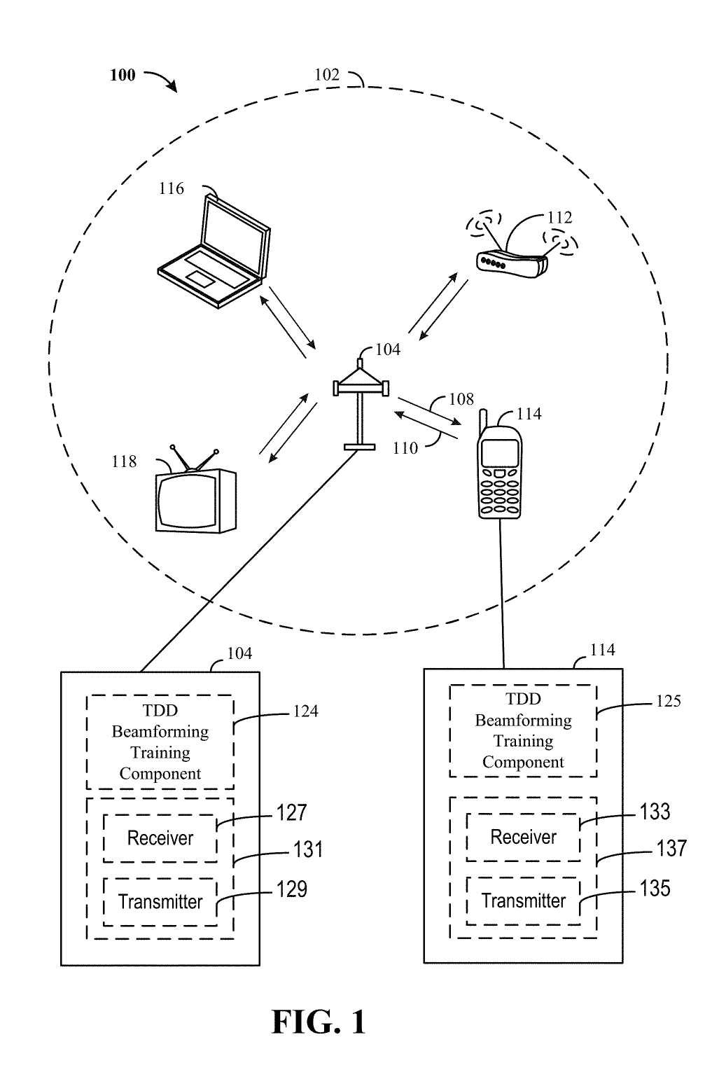

FIG. 1 shows an example wireless communication system 100 in which aspects of the present disclosure may be employed. The wireless communication system 100 may operate pursuant to a wireless standard such as, for example, those described above. The wireless communication system 100 may include an AP 104, which communicates with STAs (such as STAs 112, 114, 116, and 118).

A variety of processes and techniques may be used for the transmission and reception of communications in the wireless communication system 100 between the AP 104 and the STAs, as well as directly between STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (such as the BSA 102) is the coverage area of an AP (such as the AP 104). The AP 104 along with the STAs associated with the AP 104 that use the AP 104 for communication may be referred to as a basic service set (BSS). It should be noted that the wireless communication system 100 may not have a scheduling AP (such as AP 104), but rather may function as a peer-to-peer network between the STAs. Accordingly, the functions of the AP 104 described herein may alternatively be performed by one or more of the STAs.

The AP 104 may transmit on one or more channels (such as multiple narrowband channels, each channel including a frequency bandwidth) a beacon signal (or simply a “beacon”), via a communication link, such as the downlink 108, to other nodes (STAs) of the wireless communication system 100. The beacons may help the other nodes (STAs) to synchronize their clocks with the AP 104, as well as provide other information or functionality. Such beacons may be transmitted periodically. In some aspects, the period between successive transmissions may be referred to as a superframe. Transmission of a beacon may be divided into a number of groups or intervals. In some aspects, the beacon may include, but is not limited to, such information as timestamp information to set a common clock, a peer-to-peer network identifier, a device identifier, capability information, a superframe duration, transmission direction information, reception direction information, a neighbor list, or an extended neighbor list, some of which are described in additional detail below. Thus, a beacon may include information that is both common (such as shared) amongst several devices and specific to a given device.

In some aspects, a STA (such as STA 114) may be required to associate with the AP 104 to send communications to and receive communications from the AP 104. In some aspects, information for associating is included in a beacon broadcast by the AP 104. To receive such a beacon, the STA 114 may, for example, perform a broad coverage search over a coverage region. A search also may be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

Generally, the AP 104 (or the STA 114 in another aspect) may include one or more components for performing various functions. The AP 104 includes a receiver 127 and a transmitter 129. The receiver 127 and the transmitter 129 may receive signal from, and transmit signals to, an STA (such as STA 114) using one or more antenna arrays. Each of the antenna arrays may have one or more sectors to form directional antenna beams. The receiver 127 may be configured to perform any receiving function described herein. The transmitter 129 may be configured to perform any transmitting function described herein. The receiver 127 and the transmitter 129 may be combined into a transceiver 131.

For example, the AP 104 (or the STA 114 in another aspect) may include a TDD beamforming training component 124 to perform procedures related to one or more techniques for beamforming training using TDD access described herein. As an example, the TDD beamforming training component 124 may be configured to use TDD slots allocated for the STA 114 in an existing TDD access schedule to perform beamforming training between the AP 104 and the STA 114. In another example, the TDD beamforming training component 124 may be configured to transmit a sector sweep (SSW) frame to the STA 114 in a TDD slot allocated for transmitting from the AP 104 to the STA 114 to command the STA 114 to change its antenna configuration to sweep its receiving (Rx) antenna through a new sector. In another example, the TDD beamforming training component 124 may be configured to receive a SSW feedback frame from the STA 114 in a TDD slot allocated for transmitting from the STA 114 to the AP 104 so the AP 104 may sweep its transmitting (Tx) antenna through a new sector.

Generally, the STA 114 may include one or more components for performing various functions. For example, the STA 114 may include a TDD beamforming training component 125 to perform procedures related to beamforming training with the AP 104 to establish the desirable antenna sector at the STA 114 to communicate with an antenna sector of the AP 104 for improved signal-to-noise ratio (SNR).

The STA 114 also includes a receiver 133 and a transmitter 135. The receiver 133 may be configured to perform any receiving function described herein. The transmitter 135 may be configured to perform any transmitting function described herein. The receiver 133 and the transmitter 135 may be combined into a transceiver 137. The receiver 133 and the transmitter 135 may, respectively, receive signals from, and transmit signals to, the AP 104 or another STA using one or more antenna arrays. Each of the antenna arrays may have one or more sectors to form directional antenna beams. In some examples, the TDD beamforming training component 125 may be configured to operate in the same manner as the TDD beamforming training component 124 of the AP 104, except that the TDD beamforming training component is a component of the STA 114. As an example, the TDD beamforming training component 125 may be configured to receive a sector sweep (SSW) frame from the AP 104 in a TDD slot allocated for transmitting from the AP 104 to the STA 114. The STA 114 may change its antenna configuration to sweep its Rx antenna through a new antenna sector at the start of the SSW frame. As another example, the TDD beamforming training component 125 may be configured to transmit a SSW feedback frame to the AP 104 in a TDD slot allocated for transmitting from the STA 114 to the AP 104 so the AP 104 may sweep its Tx antenna through a new sector to establish the desirable combination of antenna sectors at the AP 104 and at the STA 114. In some examples, the STA 114 may be configured perform any technique described in this disclosure (including any combination of techniques described in this disclosure).

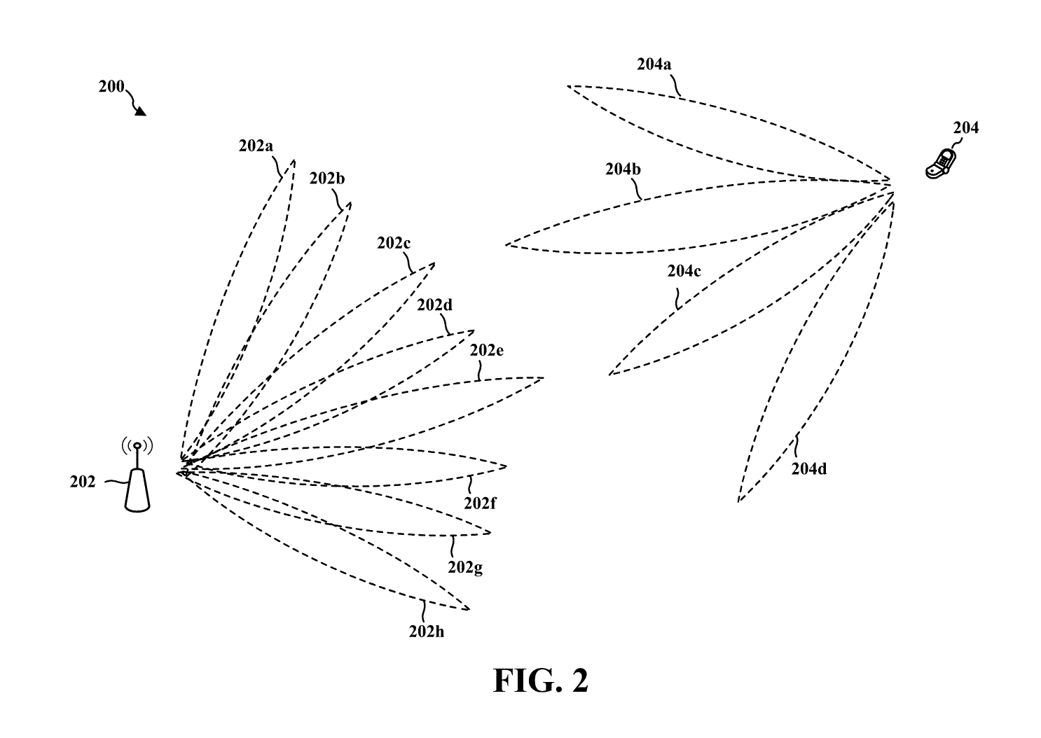

FIG. 2 is a diagram 200 illustrating antenna beam patterns from various sectors of an AP 202 and a STA 204 in communication with each other according to some implementations. The AP 202 or the STA 204 may have one or more antenna arrays. The antenna arrays may be configured to provide directional beams in a plurality of sectors. For example, multiple phased antennas arrays may be used to provide high gain antenna pattern in a direction corresponding to each sector. Referring to FIG. 2, the AP 202 may transmit a beamformed signal to the STA 204 in one or more of the sectors 202a, 202b, 202c, 202d, 202e, 202f, 202g, 202h. The STA 204 may receive the beamformed signal from the AP 202 in one or more receive sectors 204a, 204b, 204c, 204d. The STA 204 also may transmit a beamformed signal to the AP 202 in one or more of the sectors 204a-204d. The AP 202 may receive the beamformed signal from the STA 204 in one or more of the receive sectors 202a-202h. The AP 202/STA 204 may perform beamforming training to determine the receive and transmit sectors to use for each of the AP 202/STA 204. The transmit and receive sectors for the AP 202 may or may not be the same. Similarly, the transmit and receive sectors for the STA 204 may or may not be the same.

Beamforming training may be utilized under a variety of situations. For example, beamforming may be utilized when there is a degradation in an established communication link such as a decrease in the SNR in the link between the AP 202 and the STA 204. In another example, beamforming training may be utilized when the communication link is lost, such as when the STA 204 moves out of the coverage area of a sector of the AP 202. In another example, it is desired to refine the beam to a narrower sector or to better align the Tx sector with the Rx sector to improve the communication link. For example, during an initial phase of the beamforming training, an initial coarse-grain antenna sector combination between the AP 202 and STA 204 may be identified by sweeping the Tx antenna of the AP 202 through the sectors 202a-202h while fixing the Rx antenna of the STA 204 to one sector. Once the Tx antenna sector of the AP 202 yielding the largest SNR is identified, the Tx antenna of the AP 202 identified may be fixed to the identified sector while the Rx antenna sector of the STA 204 sweeps through the sectors 204a-204d to refine the sector alignment between the AP 202 and the STA 204 during a refinement phase. While the example as described sweeps the Tx antenna of the AP 202 followed by a sweep of the Rx antenna of the STA 204, beamforming training also may sweep the Tx antenna of the STA 204 followed by a sweep of the Rx antenna of the AP 202.

In another example, beamforming training may be utilized to prepare for an expected degradation or loss of the link. In another example, beamforming training may be used to establish an initial beamformed link between the AP 202 and a STA 204 that enters the coverage area of the AP 202.

In some aspects of the disclosure, beamforming training may be performed using SP with TDD channel access. Emerging WiFi standards operating in the 60 GHz frequency provide for SP that may be assigned for simplex communication between the AP 202 and the STA 204. For example, a SP within the data transmission interval (DTI) of a beacon interval (BI) may include one or more consecutive identical TDD intervals. Each TDD interval may include one or more TDD slots. A TDD slot may be assigned by the AP 202 for transmission from the AP 202 to a STA, such as STA 204, referred to as a simplex Tx TDD slot, or for transmission from a STA to the AP 202, referred to as a simplex Rx TDD slot. Different TDD slots may be assigned by the AP 202 to different STA. The AP 202 may use the TDD slots assigned to a STA in an existing TDD schedule for beamforming training between the AP 202 and the STA.

During beamforming training between a pair of devices, the device that transmits first is called the initiator and the other device is called the responder. In one example, the AP 202, as the initiator, may transmit a series of TDD SSW frames in one or more simplex Tx TDD slots assigned to the STA 204 to command the STA 204 to perform a sweep of its Rx antenna through its sectors while the AP 202 fixes its Tx antenna sector. The AP 202 may have information on the number of sectors of the Rx antenna of the STA 204. In one example, the AP 202 may have information on the minimum number of sectors for the Rx antenna to sweep at the STA 204 for the STA 204 to find a Rx antenna sector whose beamformed link meets a link budget. The STA 204 may transmit such information to the AP 202 prior to the start of the beamforming training to enable the AP 202 to determine the number of TDD SSW frames to use for the beamforming training. The AP 202 may identify one or more simplex Tx TDD slots assigned to the STA 204 that may accommodate the desired number of SSW frames.

The STA 204 may configure its Rx antenna to receive signals on a new sector at the start of receipt of a TDD SSW frame or at the start of an expected TDD SSW frame. The STA 204 may measure the SNR of the signals for each TDD SSW frame received from the AP 202 for each Rx antenna sector. The STA 204 may determine the Rx antenna configuration to use by identifying the antenna sector that yields the highest SNR from all the sectors swept. In one example, the STA 204 may find the first sector whose SNR exceeds a threshold. The STA 204 may find a simplex Rx TDD slot assigned to the STA 204 to transmit a TDD SSW feedback frame to the AP 202. The TDD SSW feedback frame may contain a sector identifier and an antenna identifier of the Rx antenna sector identified during the Rx antenna sweep as yielding the desired beamformed link. The AP 202 may receive the TDD SSW feedback frame and may change its Tx antenna sector to perform beamforming training with the STA 204 using the new Tx antenna sector. The AP 204 may successively sweep through its Tx antenna sectors by transmitting on a Tx antenna sector while commanding the STA 204 to sweep through its Rx antenna sectors using the simplex Tx TDD slots assigned to the STA 204. The AP 202 may thus use the TDD slots assigned to the STA 204 to perform beamforming training with the STA 204 to find the combination of Tx antenna sector at the AP 204 and Rx antenna sector at the STA 204 for transmission from the AP 204 to the STA 204.

In another example, the AP 202 may command the STA 204 to perform beamforming training at the next simplex Rx TDD slots assigned to the STA 204. The STA 204 may transmit a series of TDD SSW frames in one or more simplex Rx TDD slots assigned to the STA 204 to sweep its Tx antenna through its sectors while the AP 202 receives on a fixed sector of its Rx antenna or with a quasi-omni directional antenna pattern. The TDD SSW frame transmitted from the STA 204 may contain the sector identifier and antenna identifier of the Tx antenna sector used by the STA 204 to transmit the TDD SSW frame. Prior to the beamforming training, the STA 204 may transmit to the AP 202 information on the number of sectors of the Tx antenna of the STA 204. In one example, the STA 204 may transmit to the AP 202 an estimate of the minimum number of sectors that the Tx antenna at the STA 204 needs to sweep to find a Tx antenna sector whose beamformed link with the Rx antenna sector at the AP 202 meets a link budget.

The STA 204 may configure its Tx antenna to transmit signals on a new sector at the start of each TDD SSW frame. The AP 202 may measure the SNR of the signals received from the STA 204 for each TDD SSW frame. The AP 202 may determine the Tx antenna configuration to use at the STA 204 by identifying the Tx antenna sector of the STA 204 corresponding to the TDD SSW frame in which the AP measures the highest SNR. Because the AP 202 has information on the number of sectors of the Tx antenna of the STA 204, the AP knows when the STA 204 has finished sweeping through all the sectors of Tx antenna by counting the number of TDD SSW frames. In one example, the AP 202 may determine the Tx antenna configuration to use at the STA 204 by identifying the Tx antenna sector of the STA 204 corresponding to the TDD SSW frame in which the measured SNR exceeds a threshold. The AP 202 may find a simplex Tx TDD slot assigned to the STA 204 to transmit a TDD SSW feedback frame to the STA 204. The TDD SSW feedback frame may contain the sector identifier and the antenna identifier of the Tx antenna sector of the STA 204 identified during the Tx antenna sweep as yielding the desired beamformed link. The AP 202 may change its Rx antenna sector to perform beamforming training with the STA 204 using the new Rx antenna sector. The AP 202 may again command the STA 204 to perform beamforming training at the next simplex Rx TDD slots assigned to the STA 204. The AP 202 may successively sweep through its Rx antenna sectors by receiving on a Rx antenna sector while commanding the STA 204 to sweep through its Tx antenna sectors using the simplex Rx TDD slots assigned to the STA 204. The AP 202 may thus use the TDD slots assigned to the STA 204 to perform beamforming training with the STA 204 to find the combination of Rx antenna sector at the AP 202 and Tx antenna sector at the STA 204 for transmission from the STA 204 to the AP 202.

By using TDD slots assigned to a STA of an existing TDD schedule for performing beamforming training with the STA, the technique eliminates waiting for the scheduling period allocated for data transfer to expire in order to get a new schedule suitable for TDD beamforming training. It improves beamforming efficiency and shortens beamforming scheduling delays over existing solutions. The technique also improves the speed of data transfer by eliminating the need to wait for a beamforming training period such as one that is contention-based to expire in order to get a new schedule for data transfer. Using TDD SSW frames for beamforming training also improves the ability to quickly adapt the beamformed link to changing signaling environment by being able to switch the Rx or the Tx antenna sector at each TDD SSW frame, which is at least twice faster than existing solutions.

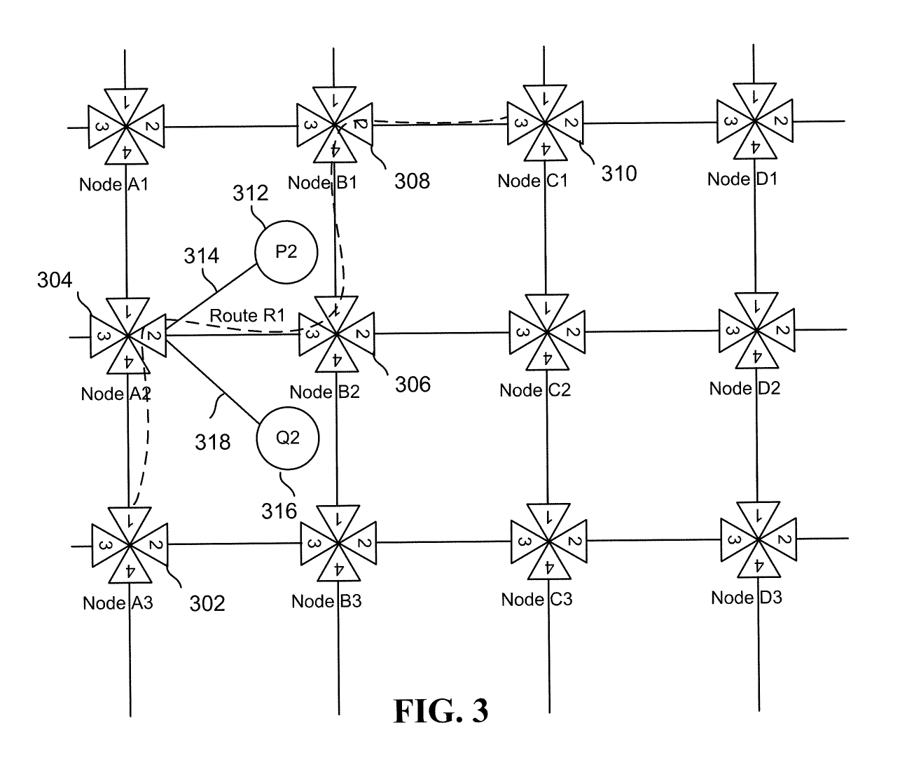

FIG. 3 shows an example of a topology of a distributed network that employs TDD access according to some implementations. The distributed network includes a meshwork of coordinating nodes, such as node A1, A2, A3, B1, B2, B3, C1, C2, C3, D1, D2, D3, etc. Each node may assume the role of an AP or a non-AP. In other aspects, the node may assume the role of a coordinating node in the personal basic service set (PBSS), called PBSS control point (PCP), that coordinates communication among the PCP and between the PCP and STA in an ad-hoc manner. The specific role assumed by a node may be defined when a node-to-node link is defined. For example, a node may become an AP or PCP and another node may become a non-AP or non-PCP, such as a STA. Each node may have a number of antennas, such as 4 antennas labeled 1-4 to provide directional beam coverage for the four quadrants around the node. Each antenna may have a number of sectors of directional beams to further increase the antenna gain. The node may communicate with each of its four neighboring nodes using a respective one of the four antennas. Each node also may act as an intermediary node to relay communication between nodes that are not immediately neighbors using the directional beams. For example, data packets from node A3 302 to node C1 310 may be transmitted from node A3 302 antenna 1 to node A2 304 antenna 4, relayed from node A2 304 antenna 2 to node B2 306 antenna 3, from node B2 306 antenna 1 to node B1 308 antenna 4, and from node B1 308 antenna 2 to node C1 310 antenna 3. The nodes also may communicate with STAs that are within the coverage of the directional beams of the antenna sectors. For example, node A2 304 antenna 2 may communicate with STA P2 312 through beamformed link 314; node A2 304 antenna 2 also may communicate with STA Q2 316 through beamformed link 318. Communication between node A2 304 antenna 2 and node B2 306 antenna 3, STA P2 312, and STA Q2 316 may be assigned to different TDD slots of the SP in a time division multiplexed manner. Communication from node A2 304 antenna 2 may proceed in parallel with the communication between node A2 304 antenna 4 and node A3 302 antenna 1.

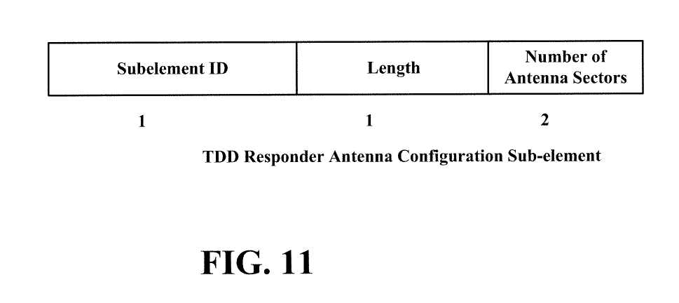

Beamforming training may be performed between node A2 304 antenna 2 and STA P2 312, STA Q2 316, and node B2 306 antenna 3 using their respectively assigned TDD slots. The STA P2 312 and STA Q2 316 may transmit to the A2 304 information on the number of sectors in their respective antennas or the number of antennas sectors to sweep for specific link conditions to shorten the time for beamforming training. The information may be defined as a sub-element, such as a TDD responder antenna configuration sub-element, in an existing information elements for TDD, as shown in FIG. 11. The node A2 304 may act as the initiator of the beamforming training by transmitting one or more TDD SSW frames in a Tx TDD slot assigned to the STA P2 312 or STA Q2 316 to command the STA P2 312 or STA Q2 316 to sweep its Rx antenna sectors while the nod A2 304 transmits on a fixed Tx antenna sector.

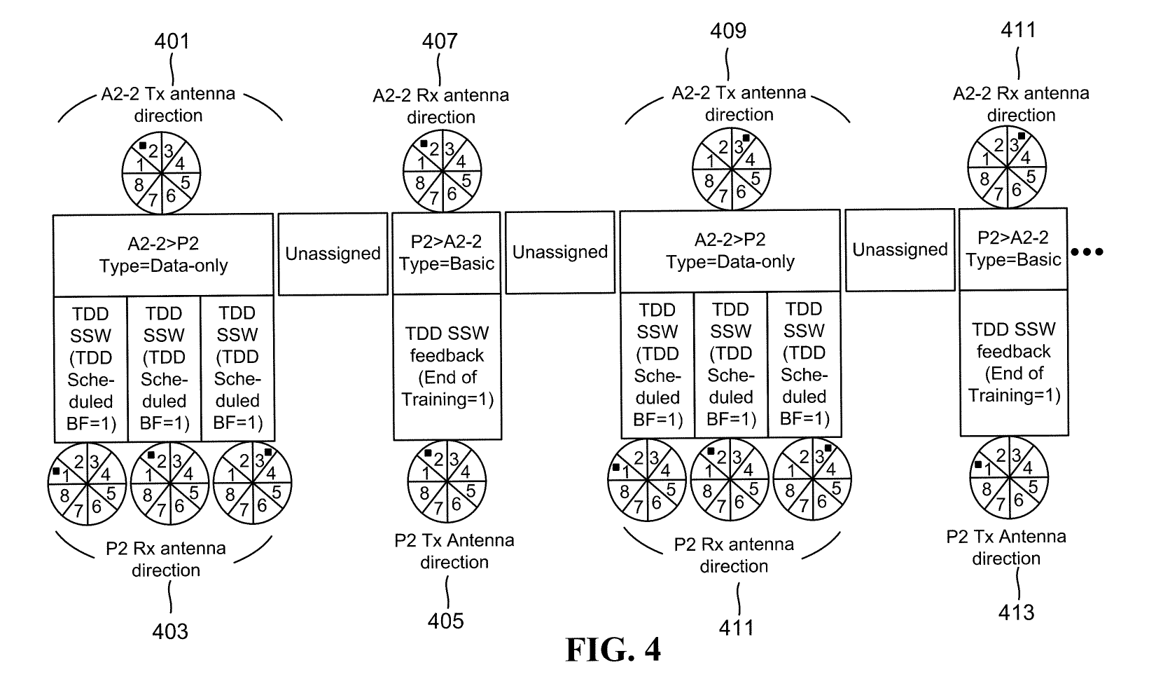

FIG. 4 shows an example of beamforming training using scheduled TDD access between the node A2 304 antenna 2 and the STA P2 312 according to one implementation. FIG. 4 shows beamforming training to find the combination of Tx antenna sector at node A2 304 antenna 2 and Rx antenna sector at STA P2 312 for transmission from node A2 304 to STA P2 312. The node A2 304 may identify the number of Tx antenna sectors at antenna 2 and receive information from STA P2 312 on its number of Rx antenna sectors to sweep. The node A2 304 may adopt a training strategy where it fixes its Tx antenna sector for antenna 2 while STA P2 312 sweeps through its Rx antenna sectors. When STA P2 312 completes its Rx antenna sweep for a first Tx antenna sector, node A2 304 may change to a new Tx antenna sector for antenna 2. Node A2 304 may fix antenna 2 to the next Tx sector while again STA P2 312 sweeps through its Rx antenna sectors. The process may repeat for the number of the Tx antenna sectors or the desired number of Tx antenna sectors for beamforming training at node A2 304 antenna 2. In another aspect, node A2 304 may adopt a training strategy where it sweeps through its Tx antennas sectors for antenna 2 while STA P2 312 fixes its Rx antenna sector. Node A2 304 may then command STA P2 312 to step its Rx antenna to a new sector and node A2 304 may repeat the sweep of the Tx antenna sectors until all combination of Tx antenna sectors at node A2 304 antenna 2 and Rx antenna sectors at STA P2 312 have been evaluated. Node A2 304 may transmit a TDD SSW frame to STA P2 312 for each combination of Tx antenna sector and Rx antenna sector. As such, the number of TDD SSW frames required for beamforming training may be a product of the number of Tx antennas sectors to sweep for node A2 304 antenna 2 and the number of Rx antennas sectors to sweep for STA P2 312. Node A2 304 may evaluate the number of Tx TDD slots assigned to STA P2 312 in the existing TDD schedule to determine if the current TDD schedule can accommodate the number of TDD SSW frames required. Node A2 304 may formulate or request a new TDD schedule with additional Tx TDD slots assigned to STA 312 if the existing TDD schedule is not enough. In some aspects, node A2 304 may supplement the existing TDD schedule with the new TDD schedule to accommodate the number of TDD SSW frames required. In another aspect, node A2 304 may use the existing TDD schedule for data transfer with STA P2 312 and use the new TDD schedule for beamforming training with STA P2 312. In another aspect, node A2 304 may use the existing TDD schedule for a combination of data transfer and beamforming training and likewise use the new TDD schedule for both data transfer and beamforming training.

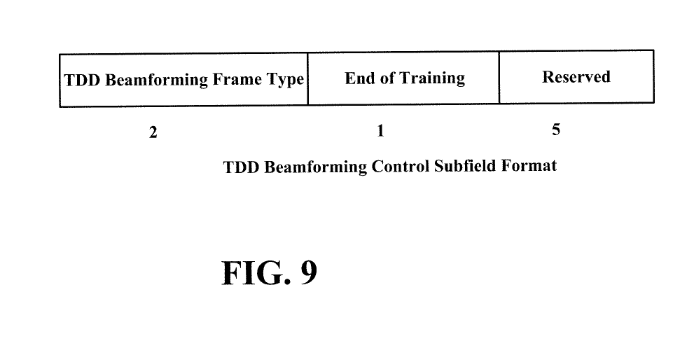

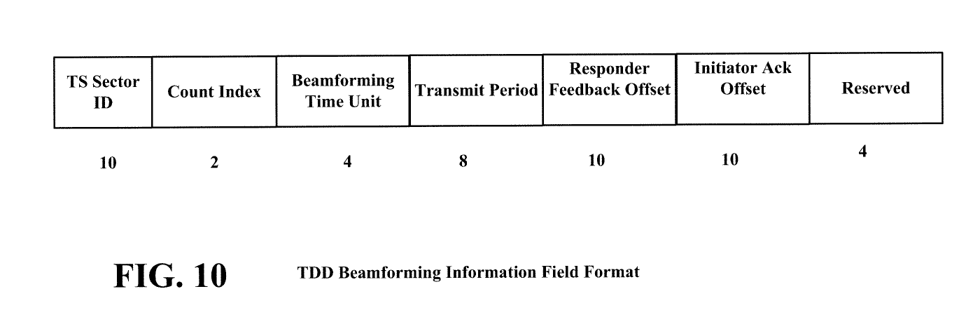

At 401 of FIG. 4, node A2 304 antenna 2 selects Tx antenna sector 2 as the first sector for beamforming training with STA P2 312. The TDD schedule may have two categories of TDD slots: the shorter basic TDD slot and the longer data-only TDD slot. In some aspects, there may be a beamforming TDD slot as a third category of TDD slots. The different categories of slots allow for better utilization of the transmission medium as the longer data-only TDD slot may be allocated for data transfer including TDD SSW frames and the shorter basic TDD slot may be allocated for feedback and acknowledgement needs and for the transfer of control and management frames including TDD SSW feedback frames. In some aspects, the beamforming TDD slot may be allocated only for the transmissions of TDD SSW frames and TDD SSW feedback frames. In 401, node A2 304 antenna 2, as the initiator, transmits three TDD SSW frames in the data-only Tx TDD slot assigned to the responder STA P2 312. In some aspects, node A2 304 may transmit the three TDD SSW frames to STA P2 312 in one or more beamforming TDD slots assigned for transmission from node A2 304 to responder STA P2 312. The TDD SSW frame may indicate that the frame is to be used for synchronized beamforming training by setting a TDD scheduled beamforming (BF) bit to 1. The TDD scheduled BF bit may be assigned to TDD beamforming control element such as a bit in the reserved subfield of the TDD Beamforming Control element, as shown in FIG. 9, or of the TDD Beamforming Information element, as shown in FIG. 10. In some aspects, transmission of a TDD SSW frame with the TDD scheduled BF bit=1 converts the entire TDD schedule to be used for TDD beamforming training. TDD SSW frames may be transmitted using the more robust Control PHY mode to facilitate beamforming measurement. The TDD SSW frame may include identification information of the Tx antenna sector of the initiator such as antenna 2 sector 2 of node A2 304.

The three TDD SSW frames command STA P2 312 to sweep its Rx antenna, one sector per TDD SSW frame, to measure the quality of the beamformed link such as by measuring the SNR. In some aspects, the number of TDD SSW frames for a fixed Tx antenna sector at the initiator is the number of Rx antennas sectors at the responder. In another aspect, the number of TDD SSW frames for a fixed Tx antennas sector at the initiator is the desired number of Rx antennas sectors to be swept at the responder. In some aspects, the TDD SSW frames for a fixed Tx antenna sector at the initiator may be transmitted in the same Tx TDD slot assigned to the responder in the TDD schedule. In another aspect, the TDD SSW frames for a fixed Tx antennas sector at the initiator may be transmitted across a number of Tx TDD slots assigned to the responder in the TDD schedule.

At 403 of FIG. 4, STA P2 312 changes its Rx antenna configuration each time the TDD SSW frame is received or expected. For example, at the expected start of the first TDD SSW frame, STA P2 312 configures its Rx antenna to sector 1 to measure the SNR of the beamformed link with node A2 304 Tx antenna 2 sector 2. Similarly, at the expected start of the second and third TDD SSW frame, STA P2 312 configures its Rx antenna to sector 2 and sector 3, respectively, to measure the SNR of the respective beamformed link. STA P2 312 may evaluate all the measured SNRs to identify the Rx antenna sector corresponding to the largest SNR as the Rx antenna sector yielding the best beamformed link with node A2 304 Tx antenna 2 sector 2. In some aspects, STA P2 312 may identify the first Rx antenna sector whose SNR exceeds a pre-determined SNR threshold as the desired Rx antenna sector for the beamformed link rather than sweeping the Rx antenna through all sectors so as to shorten the time for beamforming training.

At 405, STA P2 312 transmits a TDD SSW feedback frame to node A2 304 in a basic Rx TDD slot assigned to STA P2 312. In some aspects, STA P2 312 may transmit the TDD SSW feedback frame to node A2 304 in a beamforming TDD slot assigned for transmissions from STA P2 312 to node A2 304. The TDD SSW feedback frame may contain identification information such as a sector identifier or an antenna identifier of the sector identified in 403. STA P2 312 may transmit the TDD SSW feedback frame in the Control PHY mode using the antenna sector identified in 403. For example, STA P2 312 may identify Rx antenna sector 2 as yielding the best or the desired beamformed link to use with node A2 304 Tx antenna 2 sector 2, and may transmit a TDD SSW feedback frame containing sector identifier 2 using Tx antenna sector 2. In some aspects, if the basic Rx TDD slot assigned to the responder is not long enough to transmit the TDD SSW feedback frame in the Control PHY mode, a higher modulation and coding scheme may be used. For example, the responder may transmit the TDD SSW feedback frame using the Data PHY mode (such as Single Carrier PHY or OFDM PHY). This may be possible because a link is already established between the initiator and the responder before the beamforming training, such that beamforming training may be used to refine an established beamformed link to a narrower sector for improved SNR.

At 407, node A2 304 receives the TDD SSW feedback frame from STA P2 312. The SSW feedback frame indicates to node A2 304 the completion of beamforming training using its Tx antenna 2 sector 2 with STA P2 312. Node A2 304 may store the identification information of the Rx antenna sector of STA P2 312 identified as the best or the desired sector for forming a beamformed link with the Tx antenna 2 sector 2. Node A2 304 may select a new Tx antenna sector and may repeat beamforming training using the new Tx antenna sector. For example, at 409, node A2 304 switches Tx antenna 2 to sector 3. Node A2 304 antenna 2 transmits three TDD SSW frames in the data-only Tx TDD slot assigned to the responder STA P2 312 to command STA P2 312 to sweep its Rx antenna through three sectors. In some aspects, node A2 304 antenna 2 may transmit the three TDD SSW frames to STA P2 312 in one or more beamforming TDD slots assigned for transmission from node A2 304 to responder STA P2 312. At 411, STA P2 312 configures its Rx antenna to sweep through sectors 1, 2, and 3 to measure the SNR of the respective beamformed links with node A2 304 antenna 2 sector 3. STA P2 312 may evaluate all the measured SNRs to identify the Rx antenna sector yielding the best or the desired Rx antenna sector for forming the beamformed link with node A2 304 Tx antenna 2. sector 3. At 413, STA P2 312 transmits a TDD SSW feedback frame to node A2 304 in a basic Rx TDD slot assigned to STA P2 312 to indicate the completion of the beamforming training using Tx antenna 2 sector 3 and to identify the Rx antenna sector identified in 411. In some aspects, STA P2 312 may transmit the TDD SSW feedback frame to node A2 304 in a beamforming TDD slot assigned for transmissions from STA P2 312 to node A2 304. In 415, Node A2 304 may select a new Tx antenna sector. The process may be repeated until beamforming training is performed for all combinations of Tx antenna sectors of antenna 2 of node A2 304 and all Rx antenna sectors of STA P2 312. While one aspect of the disclosure has been described for beamforming training using TDD slots assigned to the responder, any other TDD slots in a TDD schedule also may be used. For example, slots that are allocated for emergency use or other purposes may be used for on-going TDD beamforming needs.

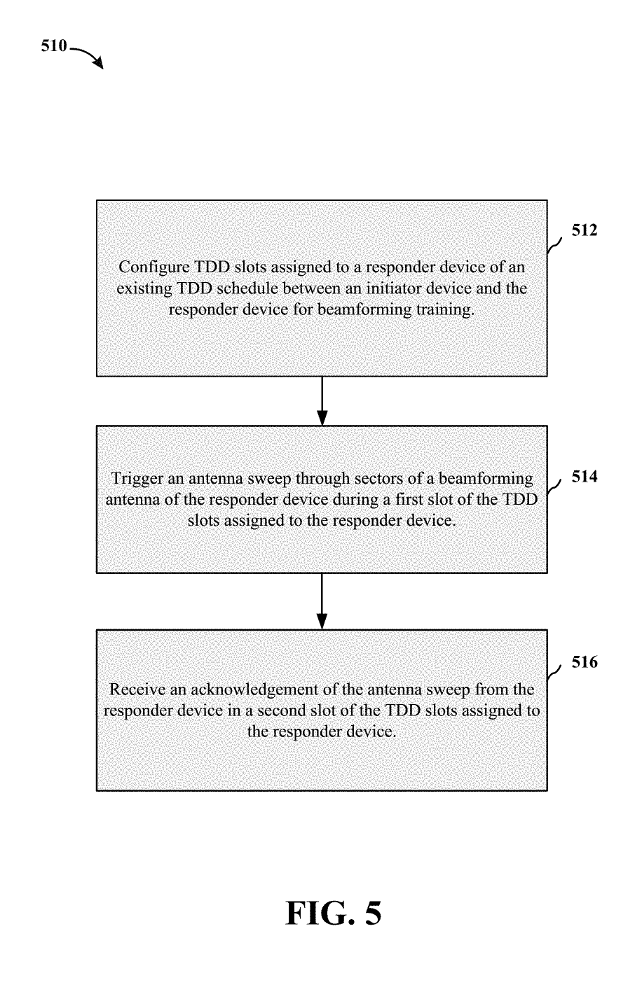

FIG. 5 is a flowchart showing an example method of beamforming training using scheduled TDD access according to one implementation. The method 510 may be performed using an apparatus (such as a WLAN AP, a UE, or a STA that implements Wi-Fi-Direct, soft AP modes or PCP, or any other device configured to perform one or more techniques described herein) such as the AP 104, 202, node A2 304, etc. The apparatus may, in some examples, be referred to as an initiator device.

At block 512, the initiator device may configure one or more TDD slots assigned to a responder device of an existing TDD schedule between the initiator device and a responder device for the beamforming training. The TDD slots may be the longer data-only TDD slots, the shorter basic TDD slots, or the beamforming TDD slots. The TDD slots may be Tx TDD slots for transmitting from the initiator device to the responder device or Rx TDD slots for transmitting from the responder device to the initiator device.

At block 514, the initiator device may be configured to trigger an antenna sweep for one or more sectors of a beamforming antenna of the responder device during a first TDD slot of the one or more slots assigned to the responder device. The first TDD slot may be a Tx TDD slot assigned to the responder device for receiving from the initiator device. In some aspects, the trigger may be TTD SSW frames containing an indication to perform synchronized TDD beamforming. The packets may be transmitted using a data-only Tx TDD slot assigned to the responder. In some aspects, the triggers or packets may be transmitted using a beamforming TDD slot allocated for transmissions of TDD SSW frames from the initiator device to the responder device.

At block 516, the initiator device may be configured to receive an acknowledgement of the antenna sweep from the responder device in a second TDD slot of the one or more slots assigned to the responder device. The second TDD slot may be a Rx TDD slot assigned to the responder device for transmitting to the initiator device. The acknowledgement may be a TDD SSW feedback frame to indicate to the initiator device that the responder device has completed its antenna sweep through its sectors. The acknowledgement may be received using a basic Rx TDD slot assigned to the responder device. In some aspects, the acknowledgement may be received using a beamforming TDD slot allocated for receiving TDD SSW feedback frames by the initiator device from the responder device.

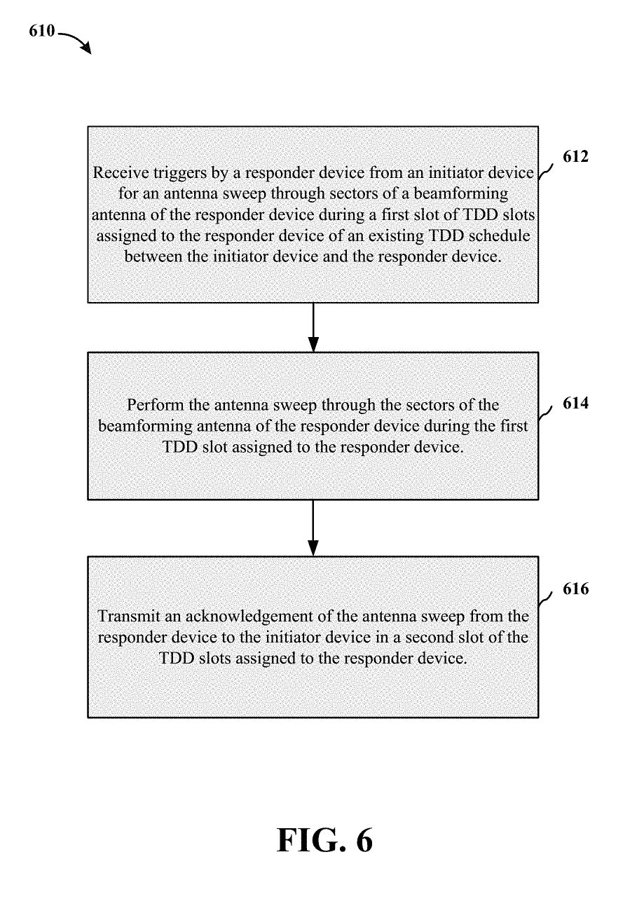

FIG. 6 is a flowchart showing another example method of beamforming training using scheduled TDD access according to one implementation. The method 610 may be performed using an apparatus (such as a WLAN STA, or any other device configured to perform one or more techniques described herein) such as the STA 114, 204, P2 314, Q2 318, etc. The apparatus may, in some examples, be referred to a responder device.

At block 612, the responder device may be configured to receive one or more triggers from an initiator device to trigger an antenna sweep for one or more sectors of a beamforming antenna of the responder device. The responder device may be configured to receive the triggers during a first TDD slot of one or more slots assigned to the responder device of an existing TDD schedule between the initiator device and the responder device. The first TDD slot may be a Tx TDD slot assigned to the responder device for receiving from the initiator device. In some aspects, the triggers may be TTD SSW frames containing an indication to perform synchronized TDD beamforming. The packets may be received using a data-only Tx TDD slot assigned to the responder. In some aspects, the triggers or packets may be received using a beamforming TDD slot allocated for receiving TDD SSW frames by the responder device from the initiator device.

At block 614, the responder device may be configured to perform the antenna sweep for the one or more sectors of the beamforming antenna of the responder device during the first TDD slot of the one or more slots assigned to the responder device. The responder device may be configured to change its Rx antenna configuration each time a packet is received or expected during the first TDD slot. The responder device may measure the quality of the beamformed links such as by measuring the SNRs of the packets received using the one or more sectors of the beamforming antenna of the responder device.

At block 616, the responder device may be configured to transmit an acknowledgement of the antenna sweep from the responder device to the initiator device in a second TDD slot of the one or more slots assigned to the responder device. The second TDD slot may be a Rx TDD slot assigned to the responder device for transmitting to the initiator device. The acknowledgement may be a TDD SSW feedback frame to indicate to the initiator device that the responder device has completed its antenna sweep through its sectors. The acknowledgement may be transmitted using a basic Rx TDD slot assigned to the responder device. In some aspects, the acknowledgement may be transmitted using a beamforming TDD slot allocated for transmitting TDD SSW feedback frames from the responder device to the initiator device.

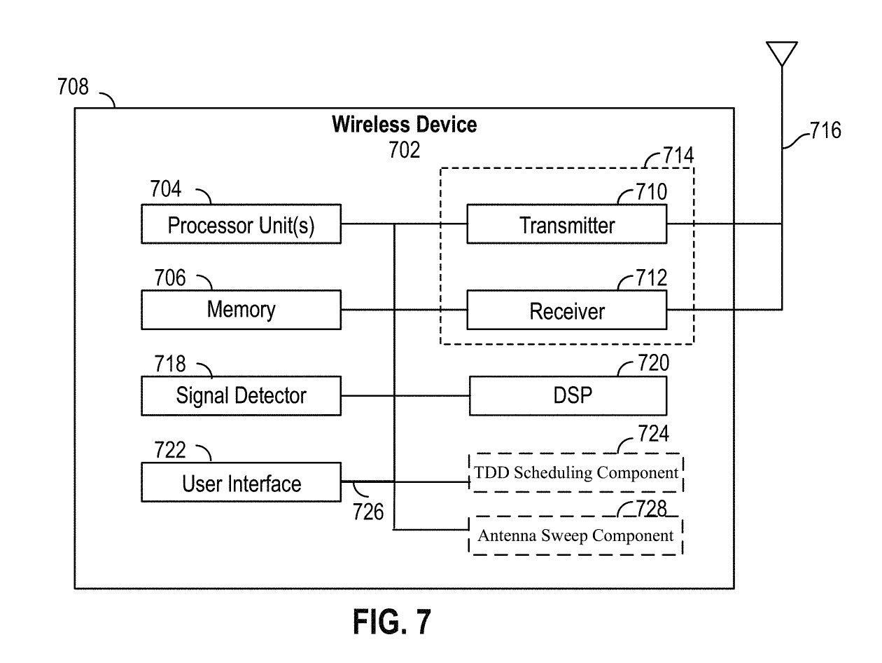

FIG. 7 shows a functional block diagram of an example wireless device 702 within the wireless communication system 100 of FIG. 1. The wireless device 702 is an example of a device that may be configured to implement the various methods described herein. For example, the wireless device 702 may include an AP (such as the AP 104/202, node A2 304) or a station (such as station 114/204 P2 314, Q2 318).

The wireless device 702 may include a processor 704 which controls operation of the wireless device 702. The processor 704 also may be referred to as a central processing unit (CPU). Memory 706, which may include both read-only memory (ROM) and random access memory (RAM), may provide instructions and data to the processor 704. A portion of the memory 706 also may include non-volatile random access memory (NVRAM). The processor 704 typically performs logical and arithmetic operations based on program instructions stored within the memory 706. The instructions in the memory 706 may be executable (by the processor 704, for example) to implement the methods described herein.

The processor 704 may include or may be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system also may include machine-readable media for storing software. Software shall be construed broadly to mean any type of instructions, whether referred to as software, firmware, middleware, microcode, hardware description language, or otherwise. Instructions may include code (such as in source code format, binary code format, executable code format, or any other suitable format of code). The instructions, when executed by the one or more processors, cause the processing system to perform the various functions described herein.

The wireless device 702 also may include a housing 708, and the wireless device 702 may include a transmitter 710 and a receiver 712 to allow transmission and reception of data between the wireless device 702 and a remote device. The transmitter 710 and the receiver 712 may be combined into a transceiver 714. An antennas 716 having multiple sectors may be attached to the housing 708 and electrically coupled to the transceiver 714. The transceiver 714 and the antenna 716 provide a means for communicating with various other apparatuses over a transmission medium. For example, the transceiver 714 may receive a signal from the antenna 716, may extract information from the received signal, and may provide the extracted information to the processor 704 or other processing component of the wireless device 702. In addition, the transceiver 714 may receive information from the processor 704 or one or more processing components of the wireless device 702, and based on the received information, may generate a signal to be applied to the antenna 716. The wireless device 702 also may include multiple transmitters, multiple receivers, multiple transceivers, or multiple antennas. The antenna 716 may have multiple sectors and may transmit and receive using any one of the multiple sectors. The antenna 716 also may use any one of the sectors to perform the beamforming training using beamformed links as described herein.

The wireless device 702 also may include a signal detector 718 that may be used to detect and quantify the level of signals received by the transceiver 714 or the receiver 712. The signal detector 718 may detect such signals as total energy, energy per subcarrier per symbol, power spectral density, SNR, and other signals. The signal detector 718 may provide a means to measure the quality of the beamformed links such as by measuring the SNR of a packet received using one of the Rx sectors of the beamforming antenna 716. In some aspects, the signal detector 718 may evaluate the measured SNRs from the multiple sectors to identify the Rx sector corresponding to the largest SNR as the desired Rx sector for a beamformed link. The wireless device 702 also may include a DSP 720 for use in processing signals. The DSP 720 may be configured to generate a packet for transmission. In some aspects, the packet may include TDD SSW frames or TDD SSW feedback frames.

The wireless device 702 may further include a user interface 722 in some aspects. The user interface 722 may include a keypad, a microphone, a speaker, or a display. The user interface 722 may include any element or component that conveys information to a user of the wireless device 702 or receives input from the user.

When the wireless device 702 is implemented as an AP (such as the AP 104), the wireless device 702 may include a TDD scheduling component 724. The TDD scheduling component 724 may use TDD slots assigned to a STA of an existing TDD schedule to perform beamforming training between the AP and the STA in accordance with the methods described herein. For example, the TDD scheduling component 724 may schedule transmissions of packets from the AP to STA to trigger an antenna sweep through multiple sectors of a beamforming antenna of the STA during a data-only Tx TDD slot assigned to the STA. In some aspects, the TDD scheduling component 724 may schedule transmissions of packets from the AP to STA using a beamforming TDD slot allocated for transmissions of TDD SSW frames from the AP to STA. The TDD scheduling component 724 also may schedule receiving an acknowledgement of the antenna sweep from the STA to the AP in a basic Rx TDD slot assigned to the STA. In some aspects, the TDD scheduling component 724 may schedule receiving an acknowledgement of the antenna sweep using a beamforming TDD slot allocated for transmissions of TDD SSW feedback frames from the STA to AP. In some implementations, the wireless device 702 may include other means, such as the processor/processing unit(s) 704, the transmitter 710, the receiver 712, the signal detector 718, or the DSP 720 for performing any of the aforementioned functions of the AP.

When the wireless device 702 is implemented as a STA (such as the STA 114), the wireless device 702 may include an antenna sweep component 728. The antenna sweep component 728 may perform an antenna sweep of a beamforming antenna of the STA through multiple antenna sectors for beamforming training during a data-only Tx TDD slot assigned to the STA. In some aspects, the antenna sweep component 728 may perform an antenna sweep during a beamforming TDD slot assigned to the STA. The antenna sweep component 728 may perform an antenna sweep by changing the sector of the beamforming antenna at the start of the expected arrival of a packet during the data-only Tx TDD slot or the beamforming TDD assigned to the STA. In some aspects, the antenna sweep component 728 may evaluate the measured SNRs from the multiple sectors to identify the Rx sector corresponding to the largest SNR as the desired Rx sector for a beamformed link. In some implementations, the wireless device 702 may include other means, such as the processor/processing unit(s) 704, the transmitter 710, the receiver 712, the signal detector 718, or the DSP 720 for performing any of the aforementioned functions of the STA.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together to accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, the antenna sweep component 728, or the TDD scheduling component 724. Further, each of the components shown and described with reference to FIG. 7 may be implemented using a plurality of separate elements.

Moreover, means for performing the various functions described herein may include the processor/processing unit(s) 704, the transmitter 710, the receiver 712, the signal detector 718, the TDD scheduling component 724, the antenna sweep component 728, or one or more other components described with respect to FIG. 1.

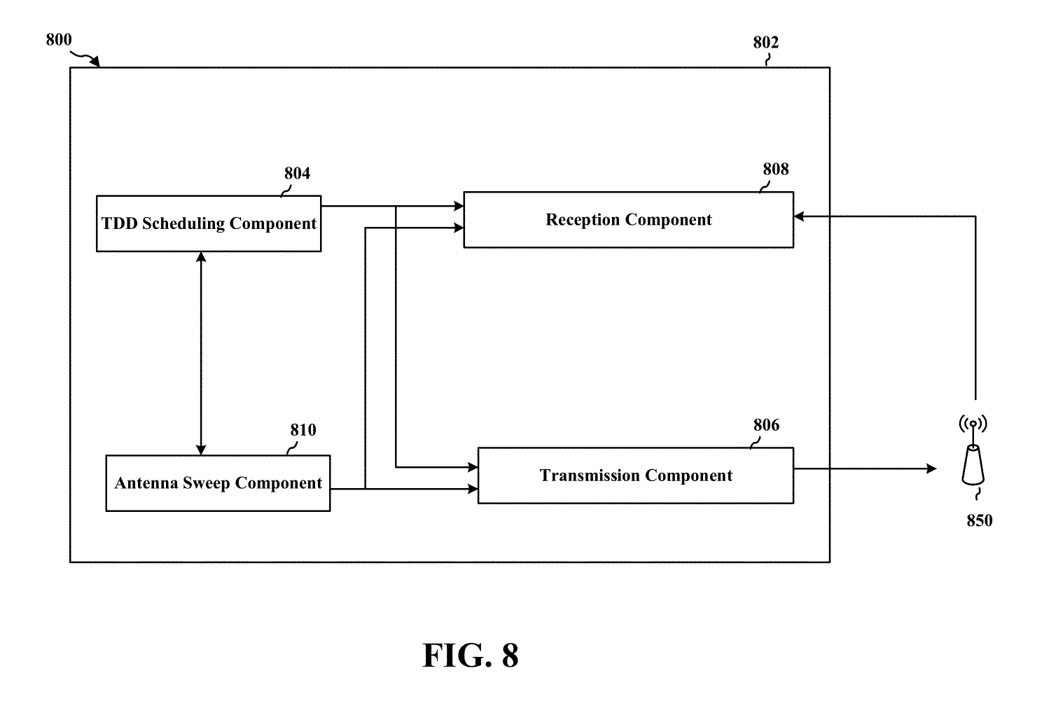

FIG. 8 is a conceptual data flow diagram 800 illustrating the data flow between different components in an apparatus 802. The apparatus may be an AP (such as AP 104/202, node A2 304). The apparatus includes a TDD scheduling component 804 configured to use TDD slots assigned to a STA of an existing TDD schedule to perform beamforming training between the AP and the STA; a transmission component 806 configured to transmit packets from a sector of the multiple sector beamforming antenna of the AP using a data-only Tx TDD slot or a beamforming TDD slot assigned to the STA to trigger the antenna sweep by the STA; and a reception component 808 configured to receive an acknowledgement of the antenna sweep from the STA to the AP in a basic Rx TDD slot or a beamforming TDD slot assigned to the STA. The apparatus 802 may be configured to transmit and receive through an antenna 850 that may have multiple sectors.

If the apparatus is a STA (such as STA 114, 204, P2 314, Q2 318), the apparatus includes an antenna sweep component 810 configured to perform an antenna sweep of a beamforming antenna of the STA through multiple antenna sectors for beamforming training during a data-only Tx TDD slot or a beamforming TDD slot assigned to the STA. The reception component 808 may be configured to receive packets from the AP to trigger the antenna sweep during the data-only Tx TDD slot or the beamforming TDD slot assigned to the STA. The transmission component 806 may be configured to transmit an acknowledgement of the antenna sweep to the AP in a basic Rx TDD slot or a beamforming TDD slot assigned to the STA.

The apparatus may include additional components that perform each of the blocks of the algorithm in the aforementioned flowcharts of FIGS. 5 and 6. As such, each block in the aforementioned flowcharts of FIGS. 5 and 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

FIG. 9 is a format for the TDD Beamforming Control Subfield. One bit of the 5-bit reserved field may be used for the TDD scheduled BF bit to indicate that the frame is to be used for synchronized beamforming. In some aspects, some bits of the 5-bit reserved field may be used to indicate the categories of TDD slots: basic, data-only, or beamforming TDD slots. The End of Training field may be used by a responder to signal to the initiator that it has completed its Rx antenna sweep and the initiator may change its Tx antenna sector.

FIG. 10 is a format for the TDD Beamforming Information Field. As in the TDD Beamforming Control field, one bit of the r-bit reserved field may be used for the TDD scheduled BF bit to indicate that the frame is to be used for synchronized beamforming. In some aspects, some bits of the 4-bit reserved field may be used to indicate the categories of TDD slots: basic, data-only, or beamforming TDD slots.

FIG. 11 is a format for the TDD Responder Antenna Configuration Sub-element. A responder may transmit to an initiator information on the number of sectors in its respective antennas or the number of antennas sectors to sweep for specific link conditions to shorten the time for beamforming training. In some aspects, the responder may transmit to the initiator the number of antenna sectors using the number of antenna sectors sub-element to allow the responder to adapt the antenna configuration to specific link conditions to shorten time for beamforming training.

The various operations of methods described above may be performed by any suitable means capable of performing the operations, such as various hardware or software component(s), a combination of hardware and software components, circuits, or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor also may be implemented as a combination of computing devices, such as a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can include RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium includes a non-transitory computer readable medium (such as tangible media).

The methods disclosed herein include one or more steps or actions for achieving the described method. The method steps or actions may be interchanged with one another without departing from the scope of the claims. In other words, unless a specific order of steps or actions is specified, the order or use of specific steps or actions may be modified without departing from the scope of the claims.

Thus, certain aspects may include a computer program product for performing the operations presented herein. For example, such a computer program product may include a computer readable medium having instructions stored (or encoded) thereon, the instructions being executable by one or more processors to perform the operations described herein. For certain aspects, the computer program product may include packaging material.

Further, it should be appreciated that components or other appropriate means for performing the methods and techniques described herein can be downloaded or otherwise obtained by a user terminal or base station as applicable. For example, such a device can be coupled to a server to facilitate the transfer of means for performing the methods described herein. Alternatively, various methods described herein can be provided via storage means (such as RAM, ROM, a physical storage medium such as a CD or floppy disk, etc.), such that a user terminal or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. For example, even though TDD slots dedicated to a STA are used for beamforming training, the aspects described may be applied to using other resources dedicated to a STA for beamforming training, such as using dedicated frequency resources. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A method of performing beamforming training by an initiator device, comprising:
configuring one or more slots assigned to a responder device of an existing time division duplex (TDD) schedule between the initiator device and the responder device for the beamforming training;
triggering an antenna sweep for one or more sectors of a beamforming antenna of the responder device during a first slot of the one or more slots assigned to the responder device; and
receiving, from the responder device, an acknowledgement of the antenna sweep in a second slot of the one or more slots assigned to the responder device.

2. The method of claim 1, wherein the one or more slots of the existing TDD schedule are allocated for data communication between the initiator device and the responder device.

3. The method of claim 1, wherein the first slot is one of a data-only TDD slot or a beamforming TDD slot allocated for the beamforming training of the existing TDD schedule.

4. The method of claim 1, wherein the second slot is one of a basic TDD slot or a beamforming TDD slot allocated for the beamforming training of the existing TDD schedule.

5. The method of claim 1, wherein the initiator device includes a beamforming antenna having one or more sectors, and wherein triggering the antenna sweep comprises:
transmitting, from a first sector of the one or more sectors of the beamforming antenna of the initiator device, one or more packets to trigger the antenna sweep by the responder device for one or more sectors of the beamforming antenna of the responder device, wherein a number of the sectors in the antenna sweep is less than or equal to a total number of sectors of the beamforming antenna of the responder device.

6. The method of claim 5, wherein receiving the acknowledgement of the antenna sweep in the second slot of the one or more slots comprises:
receiving an indication of a sector of the one or more sectors of the beamforming antenna of the responder device to be used to communicate with the first sector of the beamforming antenna of the initiator device.

7. The method of claim 6, further comprising:
transmitting, from a second sector of the one or more sectors of the beamforming antennas of the initiator device, one or more packets to trigger an antenna sweep for one or more sectors of the beamforming antenna of the responder device during a third slot of the one or more slots assigned to the responder device.

8. The method of claim 4, wherein receiving the acknowledgement of the antenna sweep in the second slot of the one or more slots comprises:
receiving the acknowledgement using a higher modulation coding scheme if a length of the basic TDD slot or the beamforming TDD slot of the existing TDD schedule is less than a length needed to transmit the acknowledgement using a lower modulation coding scheme.

9. A method of performing a beamforming training by a responder device, comprising:
receiving, from an initiator device, one or more triggers for an antenna sweep for one or more sectors of a beamforming antenna of the responder device during a first slot of one or more slots assigned to the responder device of an existing time division duplex (TDD) schedule between the initiator device and the responder device;
performing the antenna sweep for the one or more sectors of the beamforming antenna of the responder device during the first slot of the one or more slots assigned to the responder device; and
transmitting, to the initiator device, an acknowledgement of the antenna sweep in a second slot of the one or more slots assigned to the responder device.

10. The method of claim 9, wherein performing the antenna sweep for the one or more sectors of the beamforming antenna of the responder device comprises changing the sector of the beamforming antenna of the responder device at start of expected arrival of each of the one or more triggers during the first slot of the one or more slots assigned to the responder device.

11. The method of claim 9, wherein the first slot is one of a data-only TDD slot or a beamforming TDD slot allocated for the beamforming training of the existing TDD schedule.

12. The method of claim 9, wherein the second slot is one of a basic TDD slot or a beamforming TDD slot allocated for the beamforming training of the existing TDD schedule.

13. The method of claim 9, wherein the initiator device comprises a beamforming antenna having one or more sectors, and wherein receiving from the initiator device the one or more triggers for the antenna sweep comprises:
receiving, from a first sector of the one or more sectors of the beamforming antenna of the initiator device, one or more packets to trigger the antenna sweep by the responder device for the one or more sectors of the beamforming antenna of the responder device, wherein a number of the sectors in the antenna sweep is less than or equal to a total number of sectors of the beamforming antenna of the responder device.

14. The method of claim 13, wherein transmitting to the initiator device the acknowledgement of the antenna sweep in the second slot of the one or more slots comprises:
transmitting, to the initiator device, an indication of a sector of the one or more sectors of the beamforming antenna of the responder device to be used to communicate with the first sector of the beamforming antenna of the initiator device.

15. The method of claim 12, wherein transmitting to the initiator device the acknowledgement of the antenna sweep in the second slot of the one or more slots comprises:
determining that a length of the basic TDD slot or the beamforming TDD slot of the existing TDD schedule is less than a length needed to transmit the acknowledgement using a lower modulation coding scheme; and
transmitting the acknowledgement using a higher modulation scheme.

16. A first apparatus, comprising:
at least one processor; and
at least one memory communicatively coupled with the at least one processor and storing processor readable code that, when executed by the at least one processor, causes the first apparatus to:
configure one or more slots assigned to a second apparatus of an existing time division duplex (TDD) schedule between the first apparatus and the second apparatus for beamforming training;
configure a first interface to trigger an antenna sweep for one or more sectors of a beamforming antenna of the second apparatus during a first slot of the one or more slots assigned to the second apparatus; and
configure a second interface to receive, from the second apparatus, an acknowledgement of the antenna sweep in a second slot of the one or more slots assigned to the second apparatus.

17. The first apparatus of claim 16, wherein the one or more slots of the existing TDD schedule are allocated for data communication between the first apparatus and the second apparatus.

18. The first apparatus of claim 16, wherein the first slot is one of a data-only TDD slot or a beamforming TDD slot allocated for the beamforming training of the existing TDD schedule.

19. The first apparatus of claim 16, wherein the second slot is one of a basic TDD slot or a beamforming TDD slot allocated for the beamforming training of the existing TDD schedule.

20. The first apparatus of claim 16, wherein the first apparatus is part of a wireless device that comprises a beamforming antenna having one or more sectors, and wherein to trigger an antenna sweep, the at least one processor when executing the processor readable code causes the first apparatus to:
configure the first interface to transmit, from a first sector of the one or more sectors of the beamforming antenna of the wireless device, one or more packets to trigger the antenna sweep by the second apparatus for one or more sectors of the beamforming antenna of the second apparatus, wherein a number of the sectors in the antenna sweep is less than or equal to a total number of sectors of the beamforming antenna of the second apparatus.

21. The first apparatus of claim 20, wherein to receive, from the second apparatus, an acknowledgement of the antenna sweep in a second slot of the one or more slots, the at least one processor when executing the processor readable code causes the first apparatus to:
configure the second interface to receive an indication of a sector of the one or more sectors of the beamforming antenna of the second apparatus to be used to communicate with the first sector of the beamforming antenna of the wireless device.

22. The first apparatus of claim 21, wherein the at least one processor when executing the processor readable code further causes the first apparatus to:
configure the first interface to interface with the beamforming antenna of the wireless device to transmit, from a second sector of the one or more sectors of the beamforming antennas of the wireless device, one or more packets to trigger an antenna sweep for one or more sectors of the beamforming antenna of the second apparatus during a third slot of the one or more slots assigned to the second apparatus.

23. The first apparatus of claim 19, wherein to receive, from the second apparatus, an acknowledgement of the antenna sweep in a second slot of the one or more slots, the at least one processor when executing the processor readable code causes the first apparatus to:
configure the second interface to the receive the acknowledgement using a higher modulation coding scheme if a length of the basic TDD slot or the beamforming TDD slot of the existing TDD schedule is less than a length needed to transmit the acknowledgement using a lower modulation coding scheme.

24. A first apparatus, comprising:
at least one processor; and
at least one memory communicatively coupled with the at least one processor and storing processor readable code that, when executed by the at least one processor, causes the first apparatus to:
configure a first interface to receive, from a second apparatus, one or more triggers for an antenna sweep for one or more sectors of a beamforming antenna of a wireless device that comprises the first apparatus during a first slot of one or more slots assigned to the first apparatus of an existing time division duplex (TDD) schedule between the second apparatus and the first apparatus;
perform the antenna sweep for the one or more sectors of the beamforming antenna of the wireless device during the first slot of the one or more slots assigned to the first apparatus; and
configure a second interface to transmit, to the second apparatus, an acknowledgement of the antenna sweep in a second slot of the one or more slots assigned to the first apparatus.

25. The first apparatus of claim 24, wherein to perform the antenna sweep for the one or more sectors of the beamforming antenna of the wireless device, the at least one processor when executing the processor readable code causes the first apparatus to:
change the sector of the beamforming antenna of the first apparatus at start of expected arrival of each of the one or more triggers during the first slot of the one or more slots assigned to the first apparatus.

26. The first apparatus of claim 24, wherein the first slot is one of a data-only TDD slot or a beamforming TDD slot allocated for beamforming training of the existing TDD schedule.

27. The first apparatus of claim 24, wherein the second slot is one of a basic TDD slot or a beamforming TDD slot allocated for beamforming training of the existing TDD schedule.

28. The first apparatus of claim 24, wherein the second apparatus comprises a beamforming antenna having one or more sectors, and wherein to receive, from the second apparatus, one or more triggers for the antenna sweep, the at least one processor when executing the processor readable code causes the first apparatus to:
configure the first interface to receive, from a first sector of the one or more sectors of the beamforming antenna of the second apparatus, one or more packets to trigger the antenna sweep by the wireless device for the one or more sectors of the beamforming antenna of the wireless device, wherein a number of the sectors in the antenna sweep is less than or equal to a total number of sectors of the beamforming antenna of the wireless device.

29. The first apparatus of claim 28, wherein to transmit, to the second apparatus, an acknowledgement of the antenna sweep, the at least one processor when executing the processor readable code causes the first apparatus to:
configure the second interface to transmit, to the second apparatus, an indication of a sector of the one or more sectors of the beamforming antenna of the wireless device to be used to communicate with the first sector of the beamforming antenna of the second apparatus.

30. The first apparatus of claim 27, wherein to transmit, to the second apparatus, an acknowledgement of the antenna sweep, the at least one processor when executing the processor readable code causes the first apparatus to:
determine that a length of the basic TDD slot or the beamforming TDD slot of the existing TDD schedule is less than a length needed to transmit the acknowledgement using a lower modulation coding scheme; and
configure the second interface to transmit the acknowledgement using a higher modulation scheme.
